(19) United States
(12) Patent Application Publication
(10) Pub. No.: US 2009/0011057 A1
(43) Pub. Date: Jan. 8, 2009

(54) FORMULATIONS AND METHODS FOR INHIBITING ANAEROBES, GRAM NEGATIVE BACTERIA, PROTOZOA AND OTHER MICROBIAL GROWTH WITH MORINDA CITRIFOLIA L. ENHANCED FORMULATIONS

(76) Inventors: Afa Kehaati Palu, American Pork, UT (US); Brett Justin West, Orem, UT (US); Claude Jarakae Jensen, Cedar Hills, UT (US)

Correspondence Address: KIRTON AND MCCONKIE, 60 EAST SOUTH TEMPLE,, SUITE 1800, SALT LAKE CITY, UT, 84111, US

(21) Appl. No.: 12/167,011

(22) Filed: Jul. 2, 2008

Related U.S. Application Data
(60) Provisional application No. 60/948,027, filed on Jul. 5, 2007.

(51) Int. Cl. A01N 65/00; A01P 1/00

(52) U.S. Cl. 424/732; 424/777; 424/765; 424/766; 424/774

(57) ABSTRACT

The invention relates to the administration of products enhanced with Morinda citrifolia L. in order to inhibit anaerobes, gram negative bacteria, protozoa and other microbial growth related to various maladies and illnesses which result in detrimental physiological effects.

### RELATED APPLICATIONS

This application claims priority to U.S. Provisional Application Ser. No. 60/948,027, filed Jul. 5, 2007, entitled, “Formulations and Methods for Inhibiting Anaerobes, Gram Negative Bacteria, Protozoa and Other Microbial Growth with Morinda Citrifolia L. Enhanced Formulations.”

### BACKGROUND

1. Field of Invention

The field of the invention relates to products which may be administered to produce desirable physiological improvement. In particular, the invention relates to the administration of products enhanced with Morinda citrifolia L. in order to inhibit anaerobes, gram negative bacteria, protozoa and other microbial growth related to various maladies and illnesses which result in detrimental physiological effects.

2. Background

Inhibition of anaerobes, gram negative bacteria, protozoa and other microbial growth is implicated in treatment for various maladies which afflict humans and animals alike.

Actinomyces is a genus of Gram-positive bacteria. Many Actinomyces species are opportunistic pathogens of humans and other mammals, particularly in the oral cavity. In rare cases, these bacteria can cause actinomycsis, a disease characterized by the formation of abscesses in the mouth, lungs, or the gastrointestinal tract.

Salmonella Typhi is a serovar of Salmonella enterica (formerly known as Salmonella choleraesuis) and the cause of the disease typhoid fever. The organism can be transmitted by the fecal-oral route—it is excreted by humans in feces and may be transmitted by contaminated water, food, or by person-to-person contact (with inadequate attention to personal hygiene). Most cases of salmonellosis are caused by food infected with S. enterica, which often infects cattle and poultry, though also other animals such as domestic cats and hamsters have also been shown to be sources of infection to humans. However, investigations of vacuum cleaner bags have shown that households can act as a reservoir of the bacterium; this is more likely if the household has contact with an infection source, for example through members working with cattle or in a veterinary clinic.

Tritrichomonas foetus is the protozoan parasite that causes a venereal disease of cattle that has a clear pattern of adverse reproductive sequela in the affected female, with a carrier state in the bull in which he shows no outward signs. Presently, prevention of the disease relies on excluding infected males and females from the population of susceptible cattle. Control of this disease requires a plan to identify, isolate, and treat infected females, and eliminate or cull infected males. Improvements in culture technique and the application of newer methods are needed to enhance the likelihood of detecting and treating infected animals.

Because detection methods and treatments for the various noted anaerobes, gram negative bacteria, protozoa and other microbial growth are non-existent, expensive, or involve serious side effects, compositions containing natural products that would treat associated maladies are highly desirable.

### SUMMARY OF THE INVENTION

Some embodiments relate to formulations for inhibiting anaerobes, gram negative bacteria, protozoa and other microbial growth related to various maladies and illnesses which result in detrimental physiological effects, comprising processed Morinda citrifolia L. products and methods for administering such.

Some embodiments provide a method of treating various diseases and ailments, which comprise administering to said mammal a processed M. citrifolia product selected from a group consisting of: extract from the leaves of M. citrifolia, leaf hot water extract, processed M. citrifolia leaf ethanol extract, processed M. citrifolia leaf steam distillation extract, M. citrifolia fruit juice, M. citrifolia extract, M. citrifolia dietary fiber, M. citrifolia puree juice, M. citrifolia puree, M. citrifolia fruit juice concentrate, M. citrifolia puree juice concentrate, freeze concentrated M. citrifolia fruit juice, M. citrifolia seeds, M. citrifolia seed extracts, extracts from defatted M. citrifolia seeds and evaporated concentration of M. citrifolia fruit juice.

### DETAILED DESCRIPTION OF THE INVENTION

Some embodiments relate to formulations for inhibiting anaerobes, gram negative bacteria, protozoa and other microbial growth related to various maladies and illnesses which result in detrimental physiological effects, comprising processed Morinda citrifolia L. products and methods for administering such. It will be readily understood that the components of the present invention, as generally described herein, could be arranged and designed in a wide variety of different configurations. Thus, the following more detailed description of embodiments of the compositions and methods of the present invention is not intended to limit the scope of the invention, as claimed, but is merely representative of the presently preferred embodiments of the invention. The scope of the invention is, therefore, indicated by the appended claims rather than by the foregoing description. All changes that come within the meaning and range of equivalency of the claims are to be embraced within their scope.

General Description of the Morinda citrifolia L. Plant

The Indian Mulberry or M. citrifolia plant is known scientifically as M. citrifolia. The plant is native to Southeast Asia and has spread in early times to a vast area from India to eastern Polynesia. It grows randomly in the wild, and it has been cultivated in plantations and small individual growing plots. Although the fruit has been eaten by several nationalities as food, the most common use of the M. citrifolia plant has traditionally been as a red and yellow dye source.

Processing Morinda citrifolia L. Leaves

The leaves of the M. citrifolia plant are one possible component of the M. citrifolia plant that may be present in some compositions of the present invention. For example, some compositions comprise leaf extract and/or leaf juice as described further herein. Some compositions comprise a leaf serum that is comprised of both leaf extract and fruit juice obtained from the M. citrifolia plant. Some compositions of the present invention comprise leaf serum and/or various leaf extracts as incorporated into a nutraceutical product (“nutraceutical” herein referring to any product designed to improve the health of living organisms such as human beings or mammals).

In some embodiments of the present invention, the M. citrifolia leaf extracts are obtained using the following process. First, relatively dry leaves from the M. citrifolia plant are collected, cut into small pieces, and placed into a crushing device—preferably a hydraulic press—where the leaf pieces are crushed. In some embodiments, the crushed leaf pieces are then percolated with an alcohol such as ethanol, methanol, ethyl acetate, or other alcohol-based derivatives using methods known in the art. Next, in some embodiments, the alcohol and all alcohol-soluble ingredients are extracted from the crushed leaf pieces, leaving a leaf extract that is then reduced with heat to remove all the liquid there from. The resulting dry leaf extract will herein be referred to as the “primary leaf extract.”

In some embodiments, the primary leaf extract is subsequently pasteurized. The primary leaf extract may be pasteurized preferably at a temperature ranging from 70 to 80 degrees Celsius and for a period of time sufficient to destroy any objectionable organisms without major chemical alteration of the extract. Pasteurization may also be accomplished according to various radiation techniques or methods.

In some embodiments of the present invention, the pasteurized primary leaf extract is placed into a centrifuge decanter where it is centrifuged to remove or separate any remaining leaf juice therein from other materials, including chlorophyll. Once the centrifuge cycle is completed, the leaf extract is in a relatively purified state. This purified leaf extract is then pasteurized again in a similar manner as discussed above to obtain a purified primary leaf extract.

Preferably, the primary leaf extract, whether pasteurized and/or purified, is further fractionated into two individual fractions: a dry hexane fraction, and an aqueous methanol fraction. This is accomplished preferably in a gas chromatograph containing silicon dioxide and CH2Cl2-MeOH ingredients using methods well known in the art. In some embodiments of the present invention, the methanol fraction is further fractionated to obtain secondary methanol fractions. In some embodiments, the hexane fraction is further fractionated to obtain secondary hexane fractions.

One or more of the leaf extracts, including the primary leaf extract, the hexane fraction, methanol fraction, or any of the secondary hexane or methanol fractions may be combined with the fruit juice of the fruit of the M. citrifolia plant to obtain a leaf serum (the process of obtaining the fruit juice to be described further herein). In some embodiments, the leaf serum is packaged and frozen ready for shipment; in others, it is further incorporated into a nutraceutical product as explained herein.

Processing Morinda citrifolia L. Fruit

Some embodiments of the present invention include a composition comprising fruit juice of the M. citrifolia plant. In some embodiments the fruit may be processed in order to make it palatable for human consumption and included in the compositions of the present invention. Processed M. citrifolia fruit juice can be prepared by separating seeds and peels from the juice and pulp of a ripened M. citrifolia fruit; filtering the pulp from the juice; and packaging the juice. Alternatively, rather than packaging the juice, the juice can be immediately included as an ingredient in another product, frozen or pasteurized. In some embodiments of the present invention, the juice and pulp can be pureed into a homogenous blend to be mixed with other ingredients. Other processes include freeze drying the fruit and juice. The fruit and juice can be reconstituted during production of the final juice product. Still other processes may include air drying the fruit and juices prior to being masticated.

In a currently preferred process of producing M. citrifolia fruit juice, the fruit is either hand picked or picked by mechanical equipment. The fruit can be harvested when it is at least one inch (2-3 cm) and up to 12 inches (24-36 cm) in diameter. The fruit preferably has a color ranging from a dark green through a yellow-green up to a white color, and gradations of color in between. The fruit is thoroughly cleaned after harvesting and before any processing occurs.

The fruit is allowed to ripen or age from 0 to 14 days, but preferably for 2 to 3 days. The fruit is ripened or aged by being placed on equipment so that the fruit does not contact the ground. The fruit is preferably covered with a cloth or netting material during aging, but the fruit can be aged without being covered. When ready for further processing the fruit is light in color, such as a light green, light yellow, white or translucent color. The fruit is inspected for spoilage or for excessive green color and firmness. Spoiled and hard green fruit is separated from the acceptable fruit.

The ripened and aged fruit is preferably placed in plastic lined containers for further processing and transport. The containers of aged fruit can be held from 0 to 30 days, but preferably the fruit containers are held for 7 to 14 days before processing. The containers can optionally be stored under refrigerated conditions prior to further processing. The fruit is unpacked from the storage containers and is processed through a manual or mechanical separator. The seeds and peel are separated from the juice and pulp.

The juice and pulp can be packaged into containers for storage and transport. Alternatively, the juice and pulp can be immediately processed into a finished juice product. The containers can be stored in refrigerated, frozen, or room temperature conditions. The M. citrifolia juice and pulp are preferably blended in a homogenous blend, after which they may be mixed with other ingredients, such as flavorings, sweeteners, nutritional ingredients, botanicals, and colorings. The finished juice product is preferably heated and pasteurized at a minimum temperature of 181° F. (83° C.) or higher up to 212° F. (100° C.). Another product manufactured is M. citrifolia puree and puree juice, in either concentrate or diluted form. Puree is essentially the pulp separated from the seeds and is different than the fruit juice product described herein.

The product is filled and sealed into a final container of plastic, glass, or another suitable material that can withstand the processing temperatures. The containers are maintained at the filling temperature or may be cooled rapidly and then placed in a shipping container. The shipping containers are preferably wrapped with a material and in a manner to maintain or control the temperature of the product in the final containers.

The juice and pulp may be further processed by separating the pulp from the juice through filtering equipment. The filtering equipment preferably consists of, but is not limited to, a centrifuge decanter, a screen filter with a size from 1 micron up to 2000 microns, more preferably less than 500 microns, a filter press, a reverse osmosis filtration device, and any other standard commercial filtration devices. The operating filter pressure preferably ranges from 0.1 psig up to about 1000 psig. The flow rate preferably ranges from 0.1 g.p.m. up to 1000 g.p.m., and more preferably between 5 and 50 g.p.m. The wet pulp is washed and filtered at least once and up to 10 times to remove any juice from the pulp. The resulting pulp extract typically has a fiber content of 10 to 40 percent by weight. The resulting pulp extract is preferably pasteurized at a temperature of 181° F. (83° C.) minimum and then packed in drums for further processing or made into a high fiber product.

Processing Morinda citrifolia L. Seeds

Some M. citrifolia compositions of the present invention include seeds from the M. citrifolia plant. In some embodiments of the present invention, M. citrifolia seeds are processed by pulverizing them into a seed powder in a laboratory mill. In some embodiments, the seed powder is left untreated. In some embodiments, the seed powder is further defatted by soaking and stirring the powder in hexane—preferably for 1 hour at room temperature (Drug:Hexane—Ratio 1:10). The residue, in some embodiments, is then filtered under vacuum, defatted again (preferably for 30 minutes under the same conditions), and filtered under vacuum again. The powder may be kept overnight in a fume hood in order to remove the residual hexane.

Still further, in some embodiments of the present invention, the defatted and/or untreated powder is extracted, preferably with ethanol 50% (m/m) for 24 hours at room temperature at a drug solvent ratio of 1:2.

Processing Morinda citrifolia L. Oil

Some embodiments of the present invention may comprise oil extracted from the M. Citrifolia plant. The method for extracting and processing the oil is described in U.S. patent application Ser. No. 09/384,785, filed on Aug. 27, 1999 and issued as U.S. Pat. No. 6,214,351 on Apr. 10, 2001, which is incorporated by reference herein. The M. citrifolia oil typically includes a mixture of several different fatty acids as triglycerides, such as palmitic, stearic, oleic, and linoleic fatty acids, and other fatty acids present in lesser quantities. In addition, the oil preferably includes an antioxidant to inhibit spoilage of the oil. Conventional food grade antioxidants are preferably used.

### Compositions and Their Use

The invention relates to the administration of products enhanced with Morinda citrifolia L. in order to inhibit anaerobes, gram negative bacteria, protozoa and other microbial growth related to various maladies and illnesses which result in detrimental physiological effects.

Embodiments of the present invention also comprise methods for internally introducing a M. citrifolia composition into the body of a mammal. Several embodiments of the M. citrifolia compositions comprise various different ingredients, each embodiment comprising one or more forms of a processed M. citrifolia component as taught and explained herein.

Compositions of the present invention may comprise any of a number of M. citrifolia components such as: extract from the leaves of M. citrifolia, leaf hot water extract, processed M. citrifolia leaf ethanol extract, processed M. citrifolia leaf steam distillation extract, M. citrifolia fruit juice, M. citrifolia extract, M. citrifolia dietary fiber, M. citrifolia puree juice, M. citrifolia puree, M. citrifolia fruit juice concentrate, M. citrifolia puree juice concentrate, freeze concentrated M. citrifolia fruit juice, M. citrifolia seeds, M. citrifolia seed extracts, extracts taken from defatted M. citrifolia seeds, and evaporated concentration of M. citrifolia fruit juice. Compositions of the present invention may also include various other ingredients. Examples of other ingredients include, but are not limited to: artificial flavoring, other natural juices or juice concentrates such as a natural grape juice concentrate or a natural blueberry juice concentrate; carrier ingredients; and others as will be further explained herein.

Any compositions having the leaf extract from the M. citrifolia leaves, may comprise one or more of the following: the primary leaf extract, the hexane fraction, methanol fraction, the secondary hexane and methanol fractions, the leaf serum, or the nutraceutical leaf product.

In some embodiments of the present invention, active ingredients or compounds of M. citrifolia components may be extracted out using various procedures and processes commonly known in the art. For instance, the active ingredients may be isolated and extracted out using alcohol or alcohol-based solutions, such as methanol, ethanol, and ethyl acetate, and other alcohol-based derivatives using methods known in the art. These active ingredients or compounds may be isolated and further fractioned or separated from one another into their constituent parts. Preferably, the compounds are separated or fractioned to identify and isolate any active ingredients that might help to prevent disease, enhance health, or perform other similar functions. In addition, the compounds may be fractioned or separated into their constituent parts to identify and isolate any critical or dependent interactions that might provide the same health-benefiting functions just mentioned.

The processed Morinda citrifolia product comprises at least one of the active ingredient, such as quercetin, scopoletin and rutin, and others, for effectuating the inhibition of microbial activity. Active ingredients within the processed Morinda citrifolia product may be extracted out using various alcohol or alcohol-based solutions, such as methanol, ethanol, and ethyl acetate, and other alcohol-based derivatives using procedures and processes commonly known in the art. In some embodiments the active ingredients of scopoletin, quercetin and rutin may be present in amounts by weight ranging from 0.01-10 percent of the total formulation or composition. If desired, these amounts may be concentrated into a more potent concentration in which they are present in amounts ranging from 10 to 100 percent.

The present invention contemplates utilizing scopoletin, quercetin and rutin in combination with other compounds and/or in antimicrobial formulations. In non-limiting example scopoletin, quercetin and/or rutin may be isolated from and utilized in an antimicrobial formulation. In other non-limiting examples the scopoletin, quercetin and/or rutin may be combined with other active and in active compounds to be utilized in an antimicrobial formulation. Favorably, this invention provides a method of treating and inhibiting fungal and other microbial activity or growth with a Morinda citrifolia-based formulation without any significant tendency to cause deleterious side effects.

Any components and compositions of M. citrifolia may be further incorporated into a nutraceutical product (again, “nutraceutical” herein referring to any drug or product designed to improve the health of living organisms such as human beings or mammals). Examples of nutraceutical products may include, but are not limited to: intravenous products, topical dermal products, and various nutraceutical and other products as may be further discussed herein.

The compositions of the present invention may be formulated into any of a variety of embodiments, including oral compositions, topical dermal solutions, intravenous solutions, and other products or compositions.

Oral compositions may take the form of, for example, tablets, lozenges, aqueous or oily suspensions, dispersible powders or granules, emulsions, syrups, or elixirs. Compositions intended for oral use may be prepared according to any method known in the art, and such compositions may contain one or more agents such as sweetening agents, flavoring agents, coloring agents, and preserving agents. They may also contain one or more additional ingredients such as vitamins and minerals, etc. Tablets may be manufactured to contain one or more M. citrifolia components in admixture with non-toxic, pharmaceutically acceptable excipients that are suitable for the manufacture of tablets. These excipients may be, for example, inert diluents, granulating and disintegrating agents, binding agents, and lubricating agents. The tablets may be uncoated or they may be coated by known techniques to delay disintegration and absorption in the gastrointestinal tract and thereby provide sustained action over a longer period. For example, a time delay material such as glyceryl monostearate or glyceryl distearate may be used.

Aqueous suspensions may be manufactured to contain the M. citrifolia components in admixture with excipients suitable for the manufacture of aqueous suspensions.

Typical sweetening agents may include, but are not limited to: natural sugars derived from corn, sugar beets, sugar cane, potatoes, tapioca, or other starch-containing sources that can be chemically or enzymatically converted to crystalline chunks, powders, and/or syrups. Also, sweeteners can comprise artificial or high-intensity sweeteners, some of which may include aspartame, sucralose, stevia, saccharin, etc. The concentration of sweeteners may be between from 0 to 50 percent by weight of the M. citrifolia composition, and more preferably between about 1 and 5 percent by weight.

Typical flavoring agents can include, but are not limited to, artificial and/or natural flavoring ingredients that contribute to palatability. The concentration of flavors may range, for example, from 0 to 15 percent by weight of the M. citrifolia composition. Coloring agents may include food-grade artificial or natural coloring agents having a concentration ranging from 0 to 10 percent by weight of the M. citrifolia composition.

Typical nutritional ingredients may include vitamins, minerals, trace elements, herbs, botanical extracts, bioactive chemicals, and compounds at concentrations from 0 to 10 percent by weight of the M. citrifolia composition. Examples of vitamins include, but are not limited to, vitamins A, B1 through B12, C, D, E, Folic Acid, Pantothenic Acid, Biotin, etc. Examples of minerals and trace elements include, but are not limited to, calcium, chromium, copper, cobalt, boron, magnesium, iron, selenium, manganese, molybdenum, potassium, iodine, zinc, phosphorus, etc. Herbs and botanical extracts may include, but are not limited to, alfalfa grass, bee pollen, chlorella powder, Dong Quai powder, Echinacea root, Gingko Biloba extract, Horsetail herb, Indian mulberry, Shitake mushroom, spirulina seaweed, grape seed extract, etc. Typical bioactive chemicals may include, but are not limited to, caffeine, ephedrine, L-carnitine, creatine, lycopene, etc.

The ingredients to be utilized in a topical dermal product may include any that are safe for internalizing into the body of a mammal and may exist in various forms, such as gels, lotions, creams, ointments, etc., each comprising one or more carrier agents. The ingredients or carrier agents incorporated into systemically (e.g., intravenously) administered compositions may also comprise any known in the art.

In one exemplary embodiment, a M. citrifolia composition of the present invention comprises one or more of a processed M. citrifolia component present in an amount by weight between about 0.01 and 100 percent by weight, and preferably between 0.01 and 95 percent by weight. Several embodiments of formulations are included in U.S. Pat. No. 6,214,351, issued on Apr. 10, 2001, which are herein incorporated by reference. However, these compositions are only intended to be exemplary, as one ordinarily skilled in the art will recognize other formulations or compositions comprising the processed M. citrifolia product.

In another exemplary embodiment, the internal composition comprises the ingredients of: processed M. citrifolia fruit juice or puree juice present in an amount by weight between about 0.1-80 percent; processed M. citrifolia oil present in an amount by weight between about 0.1-20 percent; and a carrier medium present in an amount by weight between about 20-90 percent. M. citrifolia puree juice or fruit juice may also be formulated with a processed M. citrifolia dietary fiber product present in similar concentrations.

### EXAMPLES

The following example illustrates some of the embodiments of the present invention comprising the administration of a composition comprising components of the Indian Mulberry or Morinda citrifolia L. plant. These examples are not intended to be limiting in any way, but are merely illustrative of benefits, advantages, and remedial effects of some embodiments of the M. citrifolia compositions of the present invention.

As illustrated by the following Example, embodiments of the present invention have been tested. Specifically, the Example illustrates the results of in-vitro studies that confirmed that concentrates of processed M. citrifolia products (“TNJ” refers to an evaporative concentrate of M. citrifolia juice, “TNCONC” is a freeze concentrate, Noni Puree is a M. citrifolia based puree produced as described in this invention, Sample 100 is a Noni concentrate, “TNCMP1” refers to M. citrifolia evaporative concentrate, and NLF3 is Noni leaf active fractions) could have productive affects on mammalian reproductive systems. The percentage of concentration refers to the concentration strength of the particular concentrate tested; that is, the strength of concentration relative to the processed M. citrifolia product from which the concentrate was obtained.

### Example One

A study was conducted to determine the mean inhibitory concentrations of certain extracts from Morinda citrifolia against activity of common fungi and bacteria. A reproducible assay was developed, and initial studies have indicated that an antimicrobial component from Morinda citrifolia can be extracted. The study demonstrated that ethanol, methanol and ethyl acetate extracts of Morinda citrifolia were found to exhibit antimicrobial activity when tested against the bacteria, S. aureus, E. coli, and the fungi, C. albicans, T. mentagrophytes and A. niger.

In recent years, in an attempt to discover new antimicrobial compounds, many different sources have been explored. In this study a Mean Inhibitory Concentration (MIC) protocol was developed and then used to test ethanol, methanol, and ethyl acetate extracts of Morinda citrifolia, for antifungal and antimicrobial activity against Aspergillus niger (ATCC 6275); Candida albicans (ATCC 10231); Trichophyton mentagrophytes (ATCC 9533); Staphlococcus aureus (ATCC 29213); and Escherichia coli (ATCC 25922).

Liquid extracts were obtained, and tested in micro liter wells in duplicate. Quantities of the extracts, ranging from 6 ul to 200 μl, were placed in wells and dried. A McFarland 0.5 solution of each organism was prepared, and a 1/100 suspension into the appropriate media was made. This organism suspension was added to each well, and incubated for an appropriate amount of time at the appropriate temperature. Plates were then examined for growth, and MIC's were determined. All duplicate results agreed within one dilution. The ethyl acetate extracts had the least amount of antimicrobial activity, only showing activity when tested against T. mentagrophytes and S. aureus. The ethanol extracts showed antimicrobial activity against all of the organisms tested. This activity ranged from off-scale on the low end when tested against T. mentagrophytes, to high on-scale results for A. niger. Methanol extracts also had activity against all of the organisms tested, and ranged from off-scale on the low end when tested against T mentagrophytes, to high on-scale results for A. niger. These results indicate that at least some extracts of Morinda citrifolia contain antimicrobial activity. A more detailed description of this test follows.

The materials used in this test included several cultured microorganisms, namely, S. aureus ATCC 29213, E. coli ATCC 25922, C. albicans ATCC 10231, T. mentagrophytes ATCC 9533 and A. niger ATCC 6275. Initial cultures were developed as per the manufacturer's instructions. Prior to testing, S. aureus and E. coli were plated on Trypticase Soy Agar Plates, and incubated for 18-24 hours at 37° C. C. albicans, T. mentagrophytes and A. niger were plated on Saboraud Dextrose Agar plates, and incubated for 48-72 hours at 25° C.

For the microorganism suspension, microorganisms were used to prepare a 0.5 McFarland suspension in saline. 100 μl of the bacterial suspensions were added to 9.9 ml of Trypticase Soy Broth, and 100 μl of the fungal suspensions were added to 9.9 ml of Saboraud Dextrose Broth.

For the tray preparation, ethanol, methanol, and ethyl acetate extracts of Morinda citrifolia, were used in this study. Morinda citrifolia fruit juice extracts were supplied by Morinda, Inc. Each extract was used to prepare a row of micro liter wells. Wells 1 and 6 received 200 μl of extract; wells 2 and 7 received 100 μl of extract; wells 3 and 8 received 50 μl of extract; wells 4 and 9 received 25 μl of extract; wells 5 and 10 received 12.5 μl of extract; and wells 6 and 12 received 6.3 μl of extract. This resulted in each row containing a duplicate series of extract material. Ethanol extracts were placed into rows A-B of a standard microliter tray, methanol extracts were placed into rows C-D of a standard microliter tray, and ethyl acetate extracts were placed into rows E-F of a standard microliter tray. Row G received 200 μl of 95% ethyl alcohol, and Row H received nothing. Trays were then incubated at 37° C. for 48 hours and allowed to dry.

Each microorganism was inoculated into a different tray using the 1/100 suspension of microorganism in media. 100 μls were added to each well. Following inoculation, bacterial isolates were incubated for 24-48 hours at 37° C. Fungal isolates were incubated for 72 hours at 25° C. Following incubation, wells were analyzed for growth. A minimal inhibitory concentration (MIC) was determined by noting the lowest concentration of extract that inhibited growth. Results were reported as microliters of extract in the well exhibiting the MIC. Rows G and H served as extract and growth controls.
Several problems had to be overcome in developing this assay. Perhaps the most difficult, was perfecting a method of drying the compounds in such a fashion as to allow them to be resolubilized after they were inoculated. A review of the history of the development of antimicrobials indicates that early experiments in which extracts of penicillin were dried resulted in the total loss of activity. This problem was solved by using low heat for an extended period of time.

The following Tables illustrate the discovered activity. Activity is reported as the smallest volume of dried extract capable of inhibiting growth, the minimum inhibitory concentration (MIC).

TABLE 1
Activity of Ethanol Extracts

| | | |
|---|---|---|
| E. coli | 50 | μl |
| S. aureus | 12.5 | μl |
| T. mentagrophytes | ≦6.3-25 | μl |
| A. niger | 100-200 | μl |
| C. albicans | 100 | μl |

TABLE 2
Activity of Methanol Extracts

| | | |
|---|---|---|
| E. coli | 25-50 | μl |
| S. aureus | ≦6.3 | μl |
| T. mentagrophytes | ≦6.3-12.5 | μl |
| A. niger | 200 | μl |
| C. albicans | 50-100 | μl |

TABLE 3
Activity of Ethyl Acetate Extracts

| | | |
|---|---|---|
| E. coli | 200->200 | μl |
| S. aureus | 50-200 | μl |
| T. mentagrophytes | 50-100 | μl |
| A. niger | >200 | μl |
| C. albicans | >200 | μl |

TABLE 4
Extracts Tested with E. coli

| | | | | |
|---|---|---|---|---|
| Ethanol | 50 | 50 | 50 | 50 |
| Methanol | 25 | 50 | 25 | 25 |
| Ethyl Acetate | >200 | >200 | 200 | >200 |

TABLE 5
Extracts Tested with S. aureus

| | | | | |
|---|---|---|---|---|
| Ethanol | 12.5 | 12.5 | 12.5 | 12.5 |
| Methanol | ≦6.3 | ≦6.3 | ≦6.3 | ≦6.3 |
| Ethyl acetate | 50 | 50 | 200 | 200 |

TABLE 6
Extracts Tested with T. mentagrophytes

| | | | | |
|---|---|---|---|---|
| Ethanol | ≦6.3 | 25 | ≦6.3 | 25 |
| Methanol | ≦6.3 | 12.5 | ≦6.3 | 12.5 |
| Ethyl Acetate | 50 | 50 | 100 | 100 |

TABLE 7
Extracts Tested with A. niger

| | | | | |
|---|---|---|---|---|
| Ethanol | 200 | 200 | 100 | 100 |
| Methanol | 200 | 200 | 200 | 200 |
| Ethyl Acetate | >200 | >200 | >200 | >200 |

TABLE 8
Extracts Tested with C. albicans

| | | | | |
|---|---|---|---|---|
| Ethanol | 100 | 100 | 100 | 100 |
| Methanol | 100 | 100 | 50 | 50 |
| Ethyl Acetate | >200 | >200 | >200 | >200 |

The results of the test showed that activity of ethanol extracts ranged from ≦6.3 μl to 200 μl; the activity of methanol extracts ranged from ≦6.3 μl to 200 μl; the activity of ethyl acetate extracts ranged from 50μl to 200 μl; and that ethanol and methanol extracts were the most effective against all of the microorganisms tested.

This study attempts to take the first steps at isolating new antimicrobial compounds from a raw material. This “top down” approach utilized crude extracts of Morinda citrifolia. Results indicated that the ethanol and methanol had activity against all of the microorganisms tested, which further indicated the antifungal activity of Morinda citrifolia.

With the demonstration of antimicrobial activity, it can be said that there exists at least one and possibly several compounds within Morinda citrifolia that are responsible for the antimicrobial activity exhibited herein. As such, other tests and experiments will become necessary to specifically identify and isolate these. Most likely, future research will involve purifying the extracts discussed herein using standard separation techniques, which will involve defining some of the myriad of compounds that are present in these extracts. Once isolated, each can be tested for antimicrobial activity.

### Example Two

The purpose of this experiment was to determine the mean inhibitory concentration (MIC) of selected Morinda citrifolia fruit juice extracts against three common pathogenic fungi and two common bacteria.

The organism used were Aspergillus niger (ATCC 6275); Candida albicans (ATCC 10231); Trichophyton mentagrophytes (ATCC 9533); Staphlococcus aureus (ATCC 29213); and Escherichia coli (ATCC 9533).

For the Morinda citrifolia fruit juice extracts, ethanol, methanol, ethyl acetate, and aqueous extracts of were prepared using the appropriate solvents.

The sterile media preparations (1 liter) included: for fungi, a Sabouraud Dextrose Broth (SDB); for bacteria, a Mueller Hinton Broth (MHB); autoclave at 121° C. for 20 minutes.

The organism suspension preparations included plating each organism on appropriate media, incubate and confirm identity, prepare a 0.5 McFarland suspension of each organism, and add 0.1 ml of the organism to 9.9 ml of the appropriate media (SDB or MHB).

To prepare the Morinda citrifolia juice extracts, using the appropriate media, the extracts were dried and then diluted to a final concentration of 2 mg/ml. The extracts were then stored in −20° C. freezers until ready for fungal plating. These 2 mg/ml final volumes were used as Morinda citrifolia stock solutions.

Thirteen test tubes were labeled as follows in table 9:

TABLE 9
Test Tube Labels

1/1
1/2
1/4
1/8
1/16
1/32
1/64
1/128
1/256
1/512
1/1024
Growth control
Non-inoculated control

100 μl of Morinda citrifolia stock solution was added to Tube 1/1 and 100 μl to Tube 1/2. 100 μl of sterile media was added to Tubes: 1/2, 1/4, 1/8, 1/16, 1/32, 1/64, 1/128, 1/256, 1/512, 1/1024, Growth control, and Non-inoculated control.

Tube 1/2 was mixed well and 100 μl removed and added to Tube 1/4. This two-fold dilution procedure was continued for Tubes 1/8, 1/16, 1/32, 1/64, 1/128, 1/256, 1/512, and 1/1024. Discard 100 μl from Tube 1/1024. No diluted Morinda citrifolia solutions were added to Tubes GC or NC. These were the control tubes. At this point all tubes contained 100 μl.

Because we know that we started with 2 mg/ml (i.e. 2000 μg/ml) of extract stock solution, the serial two fold dilution resulted in the following concentrations of Morinda citrifolia fruit juice extract as shown in the table 10 below.

TABLE 10
Serial Dilution

| Tube # | Dilution | Concentration of Extract |
|---|---|---|
| 1 | 1/1 | 2000 μg/ml |
| 2 | 1/2 | 1000 μg/ml |
| 3 | 1/4 | 500 μg/ml |
| 4 | 1/8 | 250 μg/ml |
| 5 | 1/16 | 125 μg/ml |
| 6 | 1/32 | 62.50 μg/ml |
| 7 | 1/64 | 31.25 μg/ml |
| 8 | 1/128 | 15.13 μg/ml |
| 9 | 1/256 | 7.56 μg/ml |
| 10 | 1/512 | 3.78 μg/ml |
| 11 | 1/1024 | 1.89 μg/ml |
| 12 | GC | No extract |
| 13 | NC | No organism |

During inoculation, 100 μl of organism suspension were added to all of the tubes except Tube Non-inoculated control (NC). 100 μl of additional media was added to NC. All tubes were incubated at the appropriate temperatures and intervals—for fungi, 25° C. for 5-7 days; for bacteria, 37° C. for 24-48 hours.

The results were recorded by observing turbidity. The presence of turbidity indicated growth, while the absence of turbidity indicated inhibition of growth. For any extract, a result was valid only if there was turbidity (i.e. growth) in the Tube Growth control, and no turbidity in the Tube Non-inoculated control (i.e. no growth). The MIC was determined as the last tube in the series (i.e. the most diluted tube) with no turbidity.

The following, table 11, represents the mean inhibitory concentration (μg/ml):

TABLE 11
Mean Inhibitory Concentration (μg/ml)

| | EtOH | MeOH | EtAc |
|---|---|---|---|
| C. albicans | 1000 | 250-1000 | >2000 |
| A. niger | 1000-2000 | 1000-2000 | >2000 |
| T. mentagr. | ≦7.56 | ≦7.56 | 250-1000 |
| S. aureus | 31.25-62.50 | 31.25-62.50 | 1000-2000 |
| E. coli | 250 | 62.50-250 | >2000 |

Results indicate that the ethanol and methanol Morinda citrifolia extracts had meaningful activity against all of the microorganisms tested. Preliminary drying studies indicated that the activity using the ethanol and methanol extracts was in the 5-10 mg/ml range. Ethyl acetate extracts contained <10% of the amount found in the ethanol and methanol extracts.

From this initial phase of the study, it can clearly be established that Morinda citrifolia fruit juice or the extracts thereof exhibit a substantial amount of antifungal activity. However, each extract contains hundreds of compounds. Indeed, at 1000 μl/ml, there may be 100 compounds at concentrations of 10 μl/ml each. Thus, since the extracts tested were not purified antimicrobial compounds, even very high MIC's may be meaningful. Later tests described below set forth some specific compounds that were fractioned or extracted out of Morinda citrifolia fruit juice concentrate.

### Example Three

For the following experiment, the minimum inhibitory concentration (MIC) of an antibacterial is defined as the maximum dilution of the product that will still inhibit the growth of a test microorganism. The minimum lethal concentration (MLC) of an antibacterial is defined as the maximum dilution of the product that killed a test organism. MIC/MLC values can be determined by a number of standard test procedures. The most commonly employed methods are the tube dilution method and agar dilution methods. The tube dilution method was proposed for this product to determine the MIC, and plating aliquots from dilutions demonstrating possible inhibition of growth to determine the MLC. Serial dilutions were made of the products in bacterial growth media. The test organisms were added to the dilutions of the products, incubated, and scored for growth. All tests were performed in triplicate.

This procedure is a standard assay for antimicrobials. The procedure incorporates the content and intent of the American Society for Microbiology (ASM) recommended methodology. The tube dilution method employs dilutions of the test product in a bacterial growth media, inoculation with a predetermined test organism concentration, and visualization of growth after incubation. Tube dilution procedures are limited to products which do not precipitate or cloud the growth media within the expected endpoint range.

For the culture preparation procedure, the test organisms used were Escherichia coli 0157H7 ATCC #43888; Staphylococcus aureus ATCC #6538; Bacillus subtilis ATCC #19659; Salmonella choleraesuis serotype enteritidis ATCC #13706; Listeria monocytogenes ATCC #19111; Candida albicans ATCC #10231; and Streptococcus mutans ATCC #25175.

From stock, the test organisms were transferred to soybean casein digest broth (SCDB) and incubated at 37±2° C. for 24-48 hours for bacteria, and 20-25° C. for yeast. If needed, the suspensions were adjusted to approximately 10⁸ colony forming units (CFU) per mL, by visual turbidity, in physiological saline solution (PHSS) and a standard plate count was performed to determine starting titers. The yeast culture was plated onto Sabouraud dextrose agar (SDEX) and incubated at 20-25° C. for 2-4 days, S. mutans was incubated at 37±2° C. for 3-5 days, and all other bacteria were incubated at 37±2° C. for 18-24 hours.

For the Mean Inhibitory Concentration (MIC) test procedure, the test product was adjusted to a neutral pH for the purpose of this test. The pH was recorded before and after adjustments had been made. Each test product was diluted 1:2 serially in sterile water. Dilutions were selected that would show the MIC/MLC endpoint. Each test product evaluation was performed in triplicate for each organism. The product dilutions were added to an equal volume of 2× SCDS to provide an additional 1:2 dilution. Three positive control tubes were prepared for each test organism by mixing sterile water with equal volumes of 2× SCDB. Three negative control tubes were prepared by mixing the highest dilution tested of the test product with equal volumes of 2× SCDB. No test organisms were added to these tubes. Three media control tubes were prepared by mixing sterile water with equal volumes of 2× SCDB. No test organisms were added to these tubes either.

Approximately 0.05 mL of each test organism suspension was added to the sample and positive control tubes. The bacteria test tubes were incubated at 37±2° C. for 18-24 hours and yeast test tubes were incubated at 20-25° C. for 2-4 days. After incubation, growth was scored as negative (0) or positive (+) for each tube.

For the Mean Lethal Concentration (MLC) test procedure, only tubes suspected of not having any growth were tested. A 1.0 mL aliquot was removed from each tube and serial 1/10 dilutions were made in neutralizer broth up to 1/1000. An aliquot of each dilution was plated on neutralizer agar (NUAG). For a positive control, 10-100 CFU were plated onto NUAG. A negative control was made by plating 2× SCDB onto NUAG. The plates were incubated 20-25° C. for 2-4 days for yeast, and 37±2° C. for 18-24 hours for all bacteria except for S. mutans.

With regards to what is known as neutralization verification, the lowest dilution of the test product tested for MLC was tested for neutralization recovery for each test organism. In triplicate, 0.5 mL aliquots of the most concentrated test product were plated on NUAG. The plates were spiked with 10-100 CFU of each test organism. For comparison, three plates of NUAG without the test product were also spiked with the same 10-100 CFU for each of the test organisms.

With the exception of S. mutans, all organisms were inhibited by neutralized Morinda citrifolia concentrate at a 1:2 concentration. None of the dilutions tested were able to demonstrate lethality for any of the organisms. Neither inhibition nor lethality was demonstrated by the neutralized Morinda citrifolia concentrate when tested against S. mutans.

The MIC results for all organisms are summarized in Tables 12-18. The MLC results for each organism are summarized in Tables 19-25. Since S. mutans did not have any dilutions that were scored as having no growth for the MIC portion of the test, MLC was not performed for this organism.

The neutralization recoveries for all test organisms ranged from 40-97%. The neutralization recovery of the neutralizing media used in the study is summarized in Table 25.

TABLE 12
Mean Inhibitory Concentration Results for
Escherichia coli O157H7 ATCC #43885

| DILUTION | GROWTH +/0 | | |
|---|---|---|---|
| 1:2 | 0 | 0 | 0 |
| 1:4 | + | + | + |
| 1:8 | + | + | + |
| 1:16 | + | + | + |
| 1:32 | + | + | + |
| 1:64 | + | + | + |
| Positive | + | + | + |
| Negative | 0 | 0 | 0 |
| Media | 0 | 0 | 0 |

Titer: 7.0 × 10⁸ CFU/mL
Inoculating volume = 0.05 mL

TABLE 13
Mean Inhibitory Concentration Results for
Staphylococcus aureus ATCC #6538

| DILUTION | GROWTH +/0 | | |
|---|---|---|---|
| 1:2 | 0 | 0 | 0 |
| 1:4 | + | + | + |
| 1:8 | + | + | + |
| 1:16 | + | + | + |
| 1:32 | + | + | + |
| 1:64 | + | + | + |
| Positive | + | + | + |
| Negative | 0 | 0 | 0 |
| Media | 0 | 0 | 0 |

Titer: 6.5 × 10⁸ CFU/mL
Inoculating volume = 0.05 mL

TABLE 14
Mean Inhibitory Concentration Results for Bacillus
subtilis ATCC #19659

| DILUTION | GROWTH +/0 | | |
|---|---|---|---|
| 1:2 | 0 | 0 | 0 |
| 1:4 | + | + | + |
| 1:8 | + | + | + |
| 1:16 | + | + | + |
| 1:32 | + | + | + |
| 1:64 | + | + | + |
| Positive | + | + | + |
| Negative | 0 | 0 | 0 |
| Media | 0 | 0 | 0 |

Titer: 8.5 × 10⁷ CFU/mL
Inoculating volume = 0.05 mL

TABLE 15
Mean Inhibitory Concentration Results for
Salmonella choleraesuis serotype enteritidis ATCC #13706

| DILUTION | GROWTH +/0 | | |
|---|---|---|---|
| 1:2 | 0 | 0 | 0 |
| 1:4 | + | + | + |
| 1:8 | + | + | + |
| 1:16 | + | + | + |
| 1:32 | + | + | + |
| Positive | + | + | + |
| Negative | 0 | 0 | 0 |
| Media | 0 | 0 | 0 |

Titer: 4.8 × 10⁸ CFU/mL
Inoculating volume = 0.05 mL

TABLE 16
Mean Inhibitory Concentration Results for Listeria
monocytogenes ATCC #19111

| DILUTION | GROWTH +/0 | | |
|---|---|---|---|
| 1:2 | 0 | 0 | 0 |
| 1:4 | + | + | + |
| 1:8 | + | + | + |
| 1:16 | + | + | + |
| 1:32 | + | + | + |
| 1:64 | + | + | + |
| Positive | + | + | + |
| Negative | 0 | 0 | 0 |
| Media | 0 | 0 | 0 |

Titer: 3.9 × 10⁸ CFU/mL
Inoculating volume = 0.05 mL

TABLE 17
Mean Inhibitory Concentration Results for Candida
albicans ATCC #10231

| DILUTION | GROWTH +/0 | | |
|---|---|---|---|
| 1:2 | 0 | 0 | 0 |
| 1:4 | + | + | + |
| 1:8 | + | + | + |
| 1:16 | + | + | + |
| 1:32 | + | + | + |
| 1:64 | + | + | + |
| Positive | + | + | + |
| Negative | 0 | 0 | 0 |
| Media | 0 | 0 | 0 |

Titer: 1.3 × 10⁸ CFU/mL
Inoculating volume = 0.05 mL

TABLE 18
Mean Inhibitory Concentration Results for
Streptococcus mutans ATCC #25175

| DILUTION | GROWTH +/0 | | |
|---|---|---|---|
| 1:2 | + | + | + |
| 1:4 | + | + | + |
| 1:8 | + | + | + |
| Positive | + | + | + |
| Negative | 0 | 0 | 0 |
| Media | 0 | 0 | 0 |

Titer: 1.0 × 10⁷ CFU/mL
Inoculating volume = 0.05 mL

TABLE 19
Mean Lethal Concentration Results for Escherichia
coli 0157H7 ATCC #43588

| | | DILUTION | | | |
|---|---|---|---|---|---|
| DILUTION | REPLICATE | 10⁰ | 10⁻¹ | 10⁻² | 10⁻³ |
| 1:2 | 1 | TNTC | TNTC | TNTC | 245 |
| | 2 | TNTC | TNTC | TNTC | 239 |
| | 3 | TNTC | TNTC | TNTC | 215 |

Volume plated = 0.5 mL
TNTC = Too Numerous To Count

TABLE 20
Mean Lethal Concentration Results for
Staphylococcus aureus ATCC #6538

| | | DILUTION | | | |
|---|---|---|---|---|---|
| DILUTION | REPLICATE | 10⁰ | 10⁻¹ | 10⁻² | 10⁻³ |
| 1:2 | 1 | TNTC | TNTC | TNTC | 200 |
| | 2 | TNTC | TNTC | TNTC | 134 |
| | 3 | TNTC | TNTC | TNTC | 114 |

Volume plated = 0.5 mL
TNTC = Too Numerous To Count

TABLE 21
Mean Lethal Concentration Results for Bacillus
subtilis ATCC #19659

DILUTION

| DILUTION | REPLICATE | 10⁰ | 10⁻¹ | 10⁻² | 10⁻³ |
|---|---|---|---|---|---|
| 1:2 | 1 | 27 | 3 | 0 | 0 |
| | 2 | 25 | 2 | 0 | 0 |
| | 3 | 18 | 2 | 0 | 0 |

Volume plated = 0.5 mL

TABLE 22
Mean Lethal Concentration Results for Salmonella
choleraesuis serotype enteritidis ATCC #13706

| | | DILUTION | | | |
|---|---|---|---|---|---|
| DILUTION | REPLICATE | 10⁰ | 10⁻¹ | 10⁻² | 10⁻³ |
| 1:2 | 1 | TNTC | TNTC | 41 | 7 |
| | 2 | TNTC | TNTC | 75 | 5 |
| | 3 | TNTC | TNTC | 63 | 6 |

Volume plated = 0.5 mL
TNTC = Too Numerous To Count

TABLE 23
Mean Lethal Concentration Results for Listeria
monocytogenes ATCC #19111

| | | DILUTION | | | |
|---|---|---|---|---|---|
| DILUTION | REPLICATE | 10⁰ | 10⁻¹ | 10⁻² | 10⁻³ |
| 1:2 | 1 | TNTC | TNTC | TNTC | 109 |
| | 2 | TNTC | TNTC | TNTC | 109 |
| | 3 | TNTC | TNTC | TNTC | 179 |

Volume plated = 0.5 mL
TNTC = Too Numerous To Count

TABLE 24
Mean Lethal Concentration Results for Candida
albicans ATCC #10231

| | | DILUTION | | | |
|---|---|---|---|---|---|
| DILUTION | REPLICATE | 10⁰ | 10⁻¹ | 10⁻² | 10⁻³ |
| 1:2 | 1 | TNTC | TNTC | TNTC | 168 |
| | 2 | TNTC | TNTC | TNTC | 117 |
| | 3 | TNTC | TNTC | TNTC | 138 |

Note:
Volume plated = 0.5 mL
TNTC = Too Numerous To Count

TABLE 25
Neutralization

| | | | | | NEUTRAL- | | | | |
|---|---|---|---|---|---|---|---|---|---|
| | POSITIVE | | | | IZATION | | | | |
| | COUNT | | | | COUNT | | | | PERCENT |
| ORGANISM | 1 | 2 | 3 | AVE | 1 | 2 | 3 | AVE | RECOVERY |
| E. coli 0157H7 | 60 | 63 | 58 | 60 | 53 | 50 | 73 | 59 | 97% |
| S aureus | 48 | 65 | 38 | 50 | 49 | 44 | 42 | 45 | 89% |
| B. subtilis | 53 | 61 | 53 | 56 | 25 | 20 | 22 | 22 | 40% |
| S. choleraesuis | 38 | 43 | 36 | 39 | 34 | 34 | 31 | 33 | 85% |
| L. | 43 | 38 | 22 | 34 | 26 | 31 | 34 | 30 | 88% |
| monocytogenes | | | | | | | | | |
| C. albicans | 36 | 25 | 21 | 27 | 20 | 12 | 27 | 20 | 72% |
| S. mutans | 11 | 19 | 13 | 14 | 9 | 16 | 14 | 13 | 91% |

### Example Four

Experiments were done to identify the one or more specific compounds or fractions existing within the several Morinda citrifolia product(s) that is/are responsible for effectuating antifungal activity within the body once introduced therein.

Morinda citrifolia fruit juice was fractioned to obtain Morinda citrifolia n-hexane fractions, Morinda citrifolia CL₂CL₂, Morinda citrifolia ETOAc fractions, and Morinda citrifolia BuOH fractions, each of a specific concentration. Each of these were studied to determine their antimicrobial activity using the Aspergillus niger (ATCC 6275); Candida albicans (ATCC 10231); Staphlococcus aureus (ATCC 29213); and Escherichia coli (ATCC 9533) organisms. Other Morinda citrifolia products may also be fractioned in a similar manner as described herein.

In preparation, each extract was tested by preparing a series of concentrations in a microtiter tray. The first well of each series received 200 μl, the second 100 μl, the third 50 μl, the fourth 25 ul, the fifth 12.5 μl, and the sixth 6.3 μl. Trays were incubated at 35-37° C. for 72 hours. At this time all of the extracts had dried.

For the preparation of the organisms, ATCC isolate was plated on an appropriate media, and incubated. Following incubation, a 0.5 McFarland suspension of the organism was prepared in saline. 100 μl of this suspension was added to 9.9 ml of the appropriate media. 200 μl of the organism suspension were added to each well of the series, and used to suspend test material. An empty well was inoculated to serve as a growth control, and one well with media was not inoculated to serve as a negative control. Trays were incubated at the appropriate temperatures, for the appropriate intervals. (For the bacterial samples this was 35±2° C. for 24-48 hours. For fungi this was 20-25° C. for 5-7 days).

The growth control well was observed for the presence of turbidity, and the negative control was observed for the absence of turbidity. A result was only valid, if there was growth in the Growth Control well, and no growth in the non-inoculated well. Following this, each of the other wells were observed for the presence of turbidity. Results were recorded. The trays were then placed on a Multiskan Plate reader. Absorbance at 550 nm was recorded.

The minimum inhibitory concentration (MIC) was the last tube in the series, which was not turbid. The results of the test are presented below in the following tables, where activity is reported as mg/ml. Activity is reported as the smallest volume of the noted Morinda citrifolia product capable of inhibiting growth, the minimum inhibitory concentration (MIC).

TABLE 26
Activity of Morinda citrifolia fruit juice concentrate

| | |
|---|---|
| E. coli | 25 mg |
| S. aureus | 25 mg |
| A. niger | >50 mg |
| C. albicans | 50 mg |

TABLE 27
Activity of Morinda citrifolia hexane fraction

| | |
|---|---|
| E. coli | 25 mg |
| S. aureus | 25 mg |
| A. niger | 25 mg |
| C. albicans | 12.5 mg |

TABLE 28
Activity of Morinda citrifolia ETOAc fraction

| | |
|---|---|
| E. coli | 6.3 mg |
| S. aureus | 3.1 mg |
| A. niger | 25 mg |
| C. albicans | 12.5 mg |

TABLE 29
Activity of Morinda citrifolia n-BuOH fraction

| | | |
|---|---|---|
| E. coli | >12.5 | mg |
| S. aureus | 25 | mg |
| A. niger | >50 | mg |
| C. albicans | >50 | mg |

Morinda citrifolia fractions and extracts exhibited inhibitory and preventative activity against the organisms being tested.

Two problems were encountered in this study. The first is that there was a problem getting some of the higher concentrations of the ETOAc fractions or extracts into solution. As a result when these were read, precipitation was observed. This precipitation did not interfere with the visual readings, but did interfere with the absorbance measurements. A second problem is that the n-hexane fractions or extracts appeared to etch the plastic in the microtiter plate. This too caused problems with the absorbance, but not the visual readings. Additionally, due to a lack of supplied compounds, the fourth tray did not have sufficient n BuOH to prepare all of the concentrations. As a result the E. coli result is reported as >12.5 mg/ml.

### Example Five

Various experiments were conducted to investigate the administration of products enhanced with M. citrifolia in order to inhibit anaerobes, gram negative bacteria, protozoa and other microbial growth related to various maladies and illnesses which result in detrimental physiological effects.

In a preliminary investigations the potential usage of the M. citrifolia Noni fruit juice on bacterial species and various protozoan species, which are known to cause economic downfalls in humans and livestock industries were assessed. TNCMP1 was evaluated, in Anti-infective in Vitro assays, using 1%, 5% and 10% concentrations and determines its inhibitory effects using MIC against all three microorganisms.

| Microorganisms | Concentrations | MIC |
|---|---|---|
| A. viscosus | 5% | + |
| | 10% | + |
| S. typhimurium | 5% | + |
| | 10% | + |
| Trichomonas foetus | 5% | + |
| | 10% | + |

### Methods

Method employed in this study have been adapted from the scientific literature to maximize reliability and reproducibility. Reference standards were run as an integral part of each assay to ensure the validity of the results obtained. Materials utilized are described in the following charts.

Actinomyces viscosus

| | |
|---|---|
| Culture Medium: | Brain Heart Infusion Broth |
| Vehicle: | 1% DMSO |
| Incubation Time/Temp: | 2 days @ 37° C. |
| Incubation Volume: | 1 mL |
| Time of Assessment: | 2 days |
| Quantitation Method: | Turbidity Measurement |

Trichomonas foetus

| | |
|---|---|
| Culture Medium: | Fluid Sabouraud Medium |
| Vehicle: | 1% DMSO |
| Incubation Time/Temp: | 2 days @ 28° C. |
| Incubation Volume: | 1 mL |
| Time of Assessment: | 2 days |
| Quantitation Method: | Inhibition of growth was examined |

Salmonella typhimurium

| | |
|---|---|
| Culture Medium: | Brain Heart Infusion Broth |
| Vehicle: | 1% DMSO |
| Incubation Time/Temp: | 20 hours @ 37° C. |
| Incubation Volume: | 1 mL |
| Time of Assessment: | 1 day |
| Quantitation Method: | Turbidity Measurement |

REFERENCE COMPOUND DATA-MICROBIAL IN VITRO ASSAYS

| | | Reference | |
|---|---|---|---|
| Assay Name | Class | Compound | Concurrent |
| Actinomyces | Anaerobes | Ampicillin | 0.03 μg/mL |
| viscosus (ATCC | | | |
| 15987) | | | |
| Salmonella | Gram Negative | Gentamicin | 0.3 μg/mL |
| typhimuium (ATCC | | | |
| 13311) | | | |
| Trichomonas foetus | Protozoa | Metronidazole | 3 μg/mL |
| (Br. M. Strain) | | | |

### Summary/Conclusion

TNCMP1 was tested at final test concentrations of 0.03, 0.06, 0.125, 0.25, 0.5, 1, 5 and 10% for inhibition of A. viscosus, S. typhimurium and T. foetus growth in vitro. The Minimum Inhibitory Concentration (MIC) for TNCMP1 was 5% against all three microorganisms.

| | Class | Dose | Criteria | Results |
|---|---|---|---|---|
| Actinomyces | Anaerobes | 5% | +/− | + |
| viscosus | | | | |
| Salmonella | Gram Negative | 5% | +/− | + |
| typhimurium | | | | |
| Trichomonas | Protozoa | 5% | +/− | + |
| foetus | | | | |

MICROBIAL ASSAYS

| Assay Name | Class | Route | N = | Conc. | Criteria | Result R |
|---|---|---|---|---|---|---|
| Actinomyces | Anaerobes | Vit | 2 | 10% | +/− | + |
| viscosus | | | | | | |
| | | | 2 | 5% | +/− | + |
| | | | 2 | 1% | +/− | − |
| | | | 2 | 0.5% | +/− | − |
| | | | 2 | 0.25% | +/− | − |
| | | | 2 | 0.125% | +/− | − |
| | | | 2 | 0.06% | +/− | − |
| | | | 2 | 0.03% | +/− | − |
| Salmonella | Gram | vit | 2 | 10% | +/− | + |
| typhimurium | Negative | | | | | |
| | | | 2 | 5% | +/− | + |
| | | | 2 | 1% | +/− | − |
| | | | 2 | 0.5% | +/− | − |
| | | | 2 | 0.25% | +/− | − |
| | | | 2 | 0.125% | +/− | − |
| | | | 2 | 0.06% | +/− | − |
| | | | 2 | 0.03% | +/− | − |
| Trichomonas | Protozoa | vit | 2 | 10% | +/− | + |
| foetus | | | | | | |
| | | | 2 | 5% | +/− | + |
| | | | 2 | 1% | +/− | − |
| | | | 2 | 0.5% | +/− | − |
| | | | 2 | 0.25% | +/− | − |
| | | | 2 | 0.125% | +/− | − |
| | | | 2 | 0.06% | +/− | − |
| | | | 2 | 0.03% | +/− | − |

The present invention may be embodied in other specific forms without departing from its spirit of essential characteristics. The described embodiments are to be considered in all respects only as illustrative and not restrictive. The scope of the invention is, therefore, indicated by the appended claims, rather than by the foregoing description. All changes that come within the meaning and range of equivalency of the claims are to be embraced within their scope.

What is claimed is:

1. A formulation adapted to inhibit anaerobes, gram negative bacteria, protozoa and other microbial growth related to various maladies and illnesses which result in detrimental physiological effects comprising:
processed Morinda citrifolia L. fruit juice.

2. The formulation of claim 1, further comprising an element selected from a list consisting of grape juice, blueberry juice and apple juice.

3. The formulation of claim 1, wherein said:
processed Morinda citrifolia L. fruit juice is present in an amount by weight between about 85-99.99 percent.

4. The formulation of claim 1, further comprising at least one other ingredient selected from the group consisting of processed Morinda citrifolia L. products, food supplements, dietary supplements, other fruit juices, other natural ingredients, natural flavorings, artificial flavorings, natural sweeteners, artificial sweeteners, natural coloring, artificial coloring and a M. citrifolia product, wherein said processed M. citrifolia product comprises a processed M. citrifolia product selected from a group consisting of: extract from the leaves of M. citrifolia, leaf hot water extract present in an amount by weight between about 0.1 and 50 percent, processed M. citrifolia leaf ethanol extract present in an amount by weight between about 0.1 and 50 percent, processed M. citrifolia leaf steam distillation extract present in an amount by weight between about 0.1 and 50 percent, M. citrifolia fruit juice, M. citrifolia extract, M. citrifolia dietary fiber, M. citrifolia puree juice, M. citrifolia puree, M. citrifolia fruit juice concentrate, M. citrifolia puree juice concentrate, freeze concentrated M. citrifolia fruit juice, and evaporated concentration of M. citrifolia fruit juice.

5. The formulation of claim 1, wherein said formulation further comprises an active ingredient Quercetin present in an amount between about 0.1 and 10 percent by weight.

6. The formulation of claim 1, wherein said formulation further comprises an active ingredient Rutin present in an amount between about 0.1 and 10 percent by weight.

7. The formulation of claim 1, wherein said formulation further comprises an active ingredient scopoletin present in an amount between about 0.1 and 10 percent by weight.

8. A method of inhibiting anaerobes, gram negative bacteria, protozoa and other microbial growth related to various maladies and illnesses which result in detrimental physiological effects, which comprises:
processing a Morinda citrifolia L. product;
administering to said mammal a formulation comprising an effective amount of a processed M. citrifolia product; and
inhibiting the growth of Actinomyces, Salmonella and Tritrichomonas foetus in said mammal.

9. The method of claim 8, wherein said processed Morinda citrifolia L. product comprises a processed M. citrifolia selected from a group consisting of: extract from the leaves of M. citrifolia, leaf hot water extract present in an amount by weight between about 0.1 and 50 percent, processed M. citrifolia leaf ethanol extract present in an amount by weight between about 0.1 and 50 percent, processed M. citrifolia leaf steam distillation extract present in an amount by weight between about 0.1 and 50 percent, M. citrifolia fruit juice, M. citrifolia extract, M. citrifolia dietary fiber, M. citrifolia puree juice, M. citrifolia puree, M. citrifolia fruit juice concentrate, M. citrifolia puree juice concentrate, freeze concentrated M. citrifolia fruit juice, and evaporated concentration of M. citrifolia fruit juice.

10. The method of claim 8, wherein the formulation further comprising at least one other ingredient selected from the group consisting of processed Morinda citrifolia L. products, food supplements, dietary supplements, other fruit juices, other natural ingredients, natural flavorings, artificial flavorings, natural sweeteners, artificial sweeteners, natural coloring, and artificial coloring.

11. The method of claim 8, wherein the processing step comprises the steps of: adding a Morinda citrifolia L. product a solvent; and isolating an active ingredient from said M. citrifolia product.

12. The method of claim 11, wherein the solvent is selected from a list consisting of water, ethanol, butanol, isoproponal and ethyl acetate.

13. A method for making a formulation adapted to inhibit anaerobes, gram negative bacteria, protozoa and other microbial growth comprising the steps of:
obtaining a processed Morinda citrifolia L. freeze dried extract comprising the steps of:
freezing one or more M. citrifolia products;
defrosting said M. citrifolia product;
chopping said M. citrifolia product into small pieces;
adding an identified amount of distilled water to said M. citrifolia product to obtain a solution;
agitating said solution at an identified temperature for an identified period of time;
freeze-drying said supernatant solution to obtain said processed M. citrifolia product extract;
preparing a formulation comprising said processed M. citrifolia extract;
administering said nutraceutical to a patient; and
inhibiting the growth of Actinomyces, Salmonella and Tritrichomonas foetus in said patient.

14. The method of claim 13, further comprising the steps of:
extracting said solution with a solvent for an identified period of time;
removing any solids in said solution;
extracting the solvent from said solution under decreasing pressure; and
filtering any solids produced to obtain a supernatant solution after adding water but before agitating the solution.

15. The method of claim 13, wherein the solvent is selected from a list consisting of ethanol, methanol, butanol and ethyl acetate.

16. The method of claim 13, wherein said formulation further comprises a processed Morinda citrifolia L. hot water extract.

17. The method of claim 13, wherein said formulation further comprises a processed Morinda citrifolia L. steam distilled extract.

18. The method of claim 13, wherein said formulation further comprises processed Morinda citrifolia L. product selected from a list consisting of fruit juice, puree juice and dietary fiber.
